(19) United States
(12) Patent Application Publication
(10) Pub. No.: US 2023/0125876 A1
(43) Pub. Date: Apr. 27, 2023

(54) A FOLDABLE SCREEN FOR GREENHOUSE

(71) Applicant: INFRASCREEN SA, Neuchâtel (CH)

(72) Inventor: Benoît De Combaud, Buchillon (CH)

(21) Appl. No.: 17/904,817

(22) PCT Filed: Feb. 24, 2021
(86) PCT No.: PCT/IB2021/051555

§ 371 Date: Aug. 23, 2022

(30) Foreign Application Priority Data
Feb. 24, 2020 (CH) 00216/20

(51) Int. Cl. A01G 9/22; B32B 5/02; B32B 27/12

(52) U.S. Cl. CPC A01G 9/222; B32B 5/02; B32B 27/12; B32B 27/322

(57) ABSTRACT

A foldable screen for a greenhouse is described. A foldable filter for greenhouse, comprises a foldable substrate and at least one stack of films on the foldable substrate, wherein said at least one stack of films is adapted to —reflect solar infrared radiations in the spectral range from 850 nm to 2,000 nm, and —be transparent to solar radiations in the spectral range from 400 nm to 750 nm, wherein said at least one stack of film comprises: —a first layer of TiO2, ZTO, Si3N4 or NbOx; —a second layer of Ag on top of the first layer, and —a third layer of dielectric on top of the second layer.

### CROSS-REFERENCE

The present Application for Patent claims priority to International Patent Application No. PCT/IB2021/051555 by De Combaud, entitled “FOLDABLE SCREEN FOR GREENHOUSE”, filed Feb. 24, 2021, which claims priority to Swiss Patent Application No. 00216/20 by De Combaud, entitled “FOLDABLE SCREEN FOR GREENHOUSE”, filed Feb. 24, 2020, each of which is assigned to the assignee hereof, and each of which is expressly incorporated by reference in its entirety herein.

### BACKGROUND

The present disclosure concerns a foldable screen for greenhouse adapted to cancel or at least reduce heat stress on the plants during summer. The present disclosure also relates to a selective infrared filter apparatus comprising a first and a second screens selectively actuable as a function of the season. The present disclosure further concerns a method for operating the selective infrared screen apparatus as well as a method for manufacturing such a screen.

### DESCRIPTION OF RELATED ART

Solar radiations are in the range from 300 nm to 2,500 nm of the solar spectrum. Solar radiations can be divided into ultraviolets from 300 to 400 nm, photosynthetic active radiations in the spectral range from 400 nm to 700 nm (the so-called PAR range), and non-photosynthetic radiation in the spectral range from 700 nm to 2,500 nm. Radiations up to 750 nm may also impact photosynthesis and plant morphogenesis. For instance, it has been demonstrated that the ratio between red (660 nm) and far-red (730 nm) has a significant impact on morphogenesis. We will therefore refer to extended photosynthesis radiation (ePAR) for radiations in the spectral range from 400 nm to 750 nm.

During summertime, the air temperature and air humidity in a greenhouse may not be optimal for plant production; therefore, various techniques have been developed to improve temperature and humidity levels. One technique includes shading the greenhouse to reduce the amount of energy transferred by the sun to the greenhouse. Different shading solutions have been imagined such as fix or dynamic solutions and selective or non-selective solutions.

An aim of the present disclosure is to provide a foldable screen for greenhouse or for outdoor cultivations which obviates or at least mitigates the above disadvantages.

### SUMMARY

This aim is achieved by means of a foldable screen for greenhouse, comprising a substrate and at least one stack of films mounted on or adhering to the substrate, wherein said at least one stack of films is adapted to reflect solar infrared radiations in the spectral range from 850 nm to 2000 nm, and be transparent to solar radiations in the spectral range from 400 nm to 750 nm. In some examples, the at least one stack of film comprises:

a first layer of T1O2, ZTO, S13N4 or NBOx a second layer of Ag on top of the first layer, and a third layer of dielectric on top of the second layer.

T1O2, ZTO, S13N4 and NBOx have the advantage of a high or a very high refractive index, which is beneficial for the efficiency/selectivity of the filter.

In one example, the stack of film comprises:

said first layer of T1O2;

said second layer of Ag on top of the first layer;

said third layer of dielectric on top of the second layer.

T1O2 has the advantage of an extremely high refractive index. Depending on the conditions, the refractive index of T1O2 can be higher than 2.4, for example anywhere between 2.41 and 2.8 at 550 nm

The third layer can be the same dielectric as the first layer, or a different dielectric.

In one example, the third layer comprises T1O2, thus providing a high refractive index for the third layer as well.

In one example, the first and the third layer both comprise T1O2.

In one example, the first layer comprises TiO2 while the third layer comprises another more resistant dielectric.

Other dielectrics which are transparent to radiations in the photosynthetic part of the solar spectrum may be suitable as transparent dielectric layers including, but not limited to silicon dioxide, silicon nitride, silicon oxide, silicon oxynitride, silicon nitride, or mixtures thereof. However, material having a refractive index higher than 1.5, higher than 2.4, and an almost zero extinction coefficient may be preferred.

Some transparent conductive oxides, selected from but not limited to the group consisting of Indium Zinc Oxide (IZO), Indium Tin Oxide (ITO), Antimony Tin Oxide (ATO), indium oxide, zinc oxide, titanium oxide, tin oxide, silicon aluminum oxide and other metal oxides, or mixtures thereof could also be used as transparent dielectric layers if sufficiently thin. In some cases, dielectric with a refractive index higher than 2.4 are preferred in order to achieve the desired transparency and reflective properties.

The stack of film can comprise a seed layer of Cu, NiCr, NiCrNx or Au between said first layer and said second layer.

The stack of film can comprise a blocking layer of Cu, NiCr, NiCrNx or Au between said second layer and said third layer.

The seed layer and/or the blocking layer are beneficial for the nucleation of silver and protect it against corrosion. It also improves adhesion of the silver layer onto the dielectric layer.

A film or stack of films is said to be transparent in a range when a significant part of the radiations in that range is transmitted through the film, in particular at least 70%, preferably when at least 80% of the radiation at normal incidence at each wavelength within that range is transmitted through the film. A film is said to be reflective in a range when a significant part of the radiation within that range is reflected by the film, in particular at least 70%, preferably when at least 80% of the radiation at normal incidence at each wavelength within that range is reflected by the film.

The at least one stack of films is preferably adapted to reflect at least 90% of the solar infrared radiations in the spectral range from 850 nm to 2,500 nm.

In an example, said at least one stack of films is adapted to reject at least 20%, preferably at least 30% and even more preferable at least 40% of solar radiations in the green spectral range from 500 nm to 565 nm.

Since the filter blocks at least some of the infrared radiations, the heat stress on the plants protected by the filter is reduced.

In one example, at least one stack of film is adapted to reflect solar infrared radiations in the spectral range from 800 nm to 2,500 nm and upwards. In one example, at least one stack of film is adapted to reflect solar infrared radiations in the spectral range from 850 nm at normal incidence and to 2,500 nm.

In an example, the substrate of the filter comprises a flexible polymer film with a thickness of no more than 200 microns and preferably no more than 120 microns. The polymer is for example selected from the group comprising PEN, ETFE, polyester and polyethylene. ETFE has the advantage of being flexible, UV resistant and to absorb thermal infrared radiation.

The polymer substrate is preferably transparent to radiations between 400 and 2500 nm.

The substrate can comprise a plurality of layers.

The substrate can be mounted onto a canvas (yarn framework), such as a fabric.

The filter may comprise a plurality of parallel strips when said filter is in an unfolded configuration. The strips may be produced by cutting a foldable substrate and the stack of films. The strips may be mounted onto a canvas (yarn framework). A plurality of strips may be mounted onto a common canvas.

Air may or may not circulate between the strips, depending on how the strips are connected to the canvas.

The substrate can be a yarn such as a polymeric yarn. The stack of film can be directly coated onto the yarn.

In an example, the substrate faces cultivations while said at least one stack of films is oriented towards the sky when said filter is mounted in a greenhouse.

In an example, the foldable screen further comprises an additional layer transparent in the spectral range from 400 nm to 2,500 nm and disposed on top of the at least one stack of films.

In an example, of the stack of films realizes an enhanced metallic edge filter.

In one example, the enhanced metallic edge filter reflects solar infrared radiations in the range above 850 nm, preferably in the range above 750 nm.

The enhanced metallic edge filter comprises at least one film of metallic material and at least one film of dielectric material.

In an example, the first, second and third layers have a thickness within the range respectively from 20 nm to 25 nm, from 20 nm to 30 nm and from 30 nm to 40 nm.

Filters comprising an enhanced metallic edge filter are low pass filters and reflects solar infrared radiations in any wavelength above 750 nm. Therefore, Nir-lnfrared, Mid-Infrared and Far Infrared radiations from outside are prevented from reaching the plants protected by such a filter, thus reducing the heat-stress on the plants.

In this first example, if the substrate is intended to face the culture, it is preferably transparent to the ePAR radiations. It preferably also absorbs FIR radiations between 5000 and 20,000 nm, or preferably between 3,000 and 50,000 nm.

If on the other hand the substrate is intended to face the sky, it is preferably transparent to the radiations between 400 and 2′500 nm. It preferably also absorbs FIR radiations between 5,000 and 20,000 nm, or preferably between 3,000 and 50,000 nm.

If the filter comprises one protective layer that faces the sky, it preferably absorbs the FIR at least between 5,000 and 20,000 nm, preferably between 3,000 and 50,000 nm. A protective layer transparent to the FIR radiations might also be considered, although less optimal.

A drawback of filters comprising an enhanced metallic edge filter is that infrared radiations that are radiated by the crop, soil, plants, and structures within a greenhouse protected by such a filter are blocked within the greenhouse by the filter, thus reducing the heat losses by radiation.

However, this example has the drawback that thermal radiation that is reradiated by the vegetation and the soil in the far infrared range is also blocked by the filter, instead of being transmitted through the filter; this reduces radiative cooling.

To prevent thermal radiations radiated by the plants, soil and structure of the greenhouse, to be reflected by the filter, the filter preferably comprises a layer transparent in the ePAR range and adapted to absorb thermal radiation in the far infrared range, thereby increasing the temperature of the filter which may then radiate thermal infrared both inside and outside the greenhouse.

The additional layer is preferably a polymer which may be for example ETFE, which absorbs thermal radiations.

In an example, the substrate comprises down-conversion particles for re-emitting light radiation in a different wavelength.

Another aspect relates to a selective infrared filter apparatus for greenhouse, or for outdoor cultivations, comprising a first foldable screen as described above, and a second foldable screen comprising a substrate and at least one stack of films coated on the substrate. The at least one stack of films of the second screen is adapted to transmit at least 70%, preferably at least 80% of solar radiations within the range from 400 nm to 2,500 nm of the solar spectrum when said radiations hit said active film at normal incidence, and to reject at least 70%, preferably at least 80% or radiations within the range from 3,000 nm to 50,000 nm of the infrared spectrum.

The second screen preferably acts as a thermal screen to prevent convective heat transfer through the second filter.

The second screen may be unfolded when the temperature inside a greenhouse is low, for example in winter, to prevent heat from leaving the greenhouse by radiation in FIR wavelength ranges.

The second screen may be a foldable screen or curtain for protecting plants in a greenhouse.

The second screen may comprise a plurality of parallel strips when said filter is in an unfolded configuration. The strips may be produced by cutting a foldable substrate and the stack of films. The polymer film may be connected to a canvas (such as a yarn framework).

The strips of the second screen are preferably adjacent to each other to prevent air from flowing between the strips, thus reducing heat loss by convection.

Either of the first and second foldable screens may be unfolded to cover substantially the same area inside the greenhouse or over the outdoor cultivations.

In an example, the selective infrared filter apparatus further comprises:
a first and a second actuable structure adapted to bring said first and second foldable screen respectively from a folded configuration to an unfolded configuration and vice a versa,
driving means (e.g., driver) configured to actuate said first and second actuable structure,
at least one motor arranged to power the driving means (e.g., driver), and
a computer configured to control the driving means (e.g., driver) to selectively drive said first and second foldable screen, wherein the driving means (e.g., driver) are controlled as a function of at least one parameter.

In an example, said at least one parameter is a difference of temperature between a target temperature inside the greenhouse and the temperature outside the greenhouse.

In an example, the temperature outside the greenhouse is obtained from a first temperature sensor arranged outside the greenhouse and the temperature inside the greenhouse is obtained from a second temperature sensor, the first and second sensors being configured to send data to the computer.

In an example, the selective infrared filter apparatus further comprises at least one PAR sensor configured to send data to the computer. The PAR sensor measures the photosynthetically active radiations received by the cultivated plants as at least one parameter.

Another aspect relates to a method of operating the selective infrared filter apparatus as described above, wherein the first and second foldable filters are selectively brought from a folded configuration to an unfolded configuration and vice a versa in order to regulate the temperature inside the greenhouse around a target temperature.

In an example, the method comprises:
controlling the driving means to bring said first filter from a folded configuration to an unfolded configuration and to maintain or bring said second filter from an unfolded configuration to a folded configuration when a first condition is met, and
controlling the driving means to bring said first filter from an unfolded configuration to a folded configuration and to bring said second filter from a folded configuration to an unfolded configuration when a second condition is met.

In an example, the first condition is met when the delta temperature between the target temperature inside the greenhouse and the temperature outside the greenhouse falls below a predetermined delta value, while the second condition is met when the delta temperature between the target temperature inside the greenhouse and the temperature outside the greenhouse exceeds said predetermined delta value.

Another aspect relates to a method of manufacturing a foldable screen for greenhouse. The foldable screen comprises a foldable canvas and a plurality of strips comprising each a stack of films and a substrate. The strips are mounted on said foldable canvas to be parallel to each other when the filter is in an unfolded configuration. The method comprises the steps of:
providing a polymer substrate,
depositing several layers of coatings on said polymer substrate in order to obtain the at least one stack of films,
cutting said at least one stack of films and the substrate in strips; mounting said strips onto a canvas.

In an example, at least one stack of films is cut in strips by an ultrasonic system which melt and fuses portions of the polymer substrate with said opposite lateral edges.

### BRIEF DESCRIPTION OF THE DRAWINGS

The disclosure may be understood with the aid of the description of an example and illustrated by the figures, in which:

FIG. 1 shows a greenhouse with one or a plurality of screens,

FIG. 2 shows strips of a film interlaced with a yarn framework,

FIG. 3 is a schematic view of a stack of films according to a first example.

### DETAILED DESCRIPTION

FIG. 1 shows a greenhouse 1 with a plurality of filters in the form of screens 2 or curtains, as well as a cable mechanism 4 used to fold or unfold the screens by pulling them across or aside. Contrary to a cladding 3 which is fixed, such as a glass cladding, a screen 2 can be moved to cover or uncover the crop under production. The screens 2 are designed to shade the crop under production by partially reflecting solar spectrum.

In the example of FIG. 1, each screen 2 comprises a plurality of strips 20 which are, in the example, spaced apart so that air can flow between the strips, thus allowing heat transfer. Adjacent strips 22 may also be used. The strips may comprise a substrate, and be mounted onto a canvas, such as a yarn framework 21 with textile or polymer threads 23. The threads 23 are preferably running parallel to each other and spaced apart so that they do not shade the cultures. Several threads might be connected between the strips with threads running in an orthogonal direction.

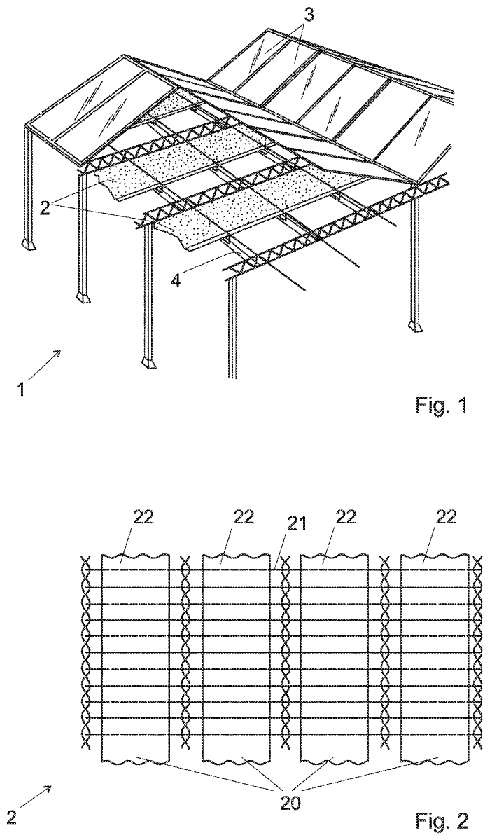

FIG. 2 shows an example of filter in the form of such a screen 2. It comprises spaced strips 20 of flexible, foldable material running in the longitudinal direction of a canvas 21. Each strip 20 comprises a substrate such as a polymer film 22 on at least one side of this fabric, and at least one stack of films that provide the filtering function and that are mounted on or adhering to the polymer film 22. The strips are mounted onto the canvas 21.

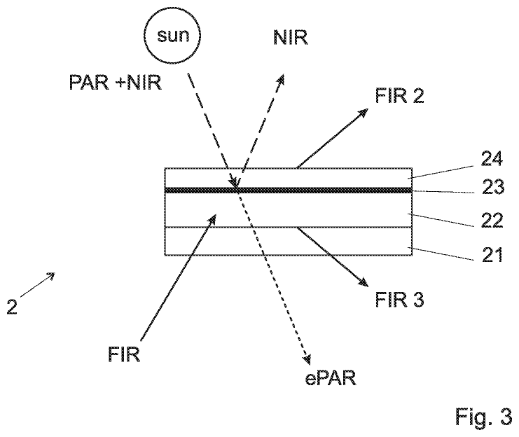

In the first example shown on FIG. 3, the filter 2 comprises a substrate 22 mounted onto a canvas 21 and onto which a stack of films 23 is coated. Optionally, a protective layer 24 may cover the stack of films 23 from mechanical or chemical aggressions.

In the example of FIG. 3, the substrate comprises a flexible polymer film 22 mounted on one side of the canvas 21. This example is well adapted to a screen for a greenhouse. In a variant of this example (not shown), the substrate comprises a yarn 21; each yarn being coated (“activated”) with a stack of film 23.

The filter of FIG. 3 acts as a low-pass filter. In one example, this filter reflects infrared radiations in a wavelength between 850 and 2500 nm, or preferably between 800 nm and 2500 nm, preferably between 750 and 2500 nm, but is transparent to radiations in the ePAR range. Therefore, the portion of the solar radiations (“sun”) in the ePAR range is transmitted to the plants inside the greenhouse or under the net, while the portion in the infrared range, in particular in the near infrared range, are reflected, thus limiting the heat stress on the plant protected by such a filter without reducing the photosynthetic active radiations.

The stack of films realizes an enhanced metallic short-wave pass filter. Contrary to interferometer filters used in the 3M™ Prestige filter, such filters have low sensitivity to the angle of incidence. They can be designed to start rejecting NIR close to the end of the ePAR spectrum range.

The filter 2 is preferably configured to:
reject a significant part (>70%, preferably >80%) of the radiations in the 750-50,000 nm range, and
transmit a significant part (>70%, preferably >80%) of the radiation in the ePAR range.

The filter may be further arranged to reject for instance 20% of the radiations in the 500 nm to 565 nm range (“green range”). Contrary to the human eye which may be sensitive to green radiation, green radiations are less photosynthetic than for instance red and blue and there is a limited impact on crop productivity below the screen but a high impact on incoming energy inside the greenhouse hence on internal temperature and crop transpiration.

The solar spectrum will predominantly be rejected by reflexion. Absorption may occur as well due to the metallic layers in the stack of films 23. In one example, this absorption is limited to for instance 10% and no more than 30% of rejected radiations depending on the material used in the different layers and their thickness.

Different configurations of the stack of films may be implemented. For example, a stack made of 3 layers as specified below may be used:
1) T1O2 with a thickness in the 20-25 nm range,
2) Ag with a thickness in the 20-30 nm range, and
T1O2 with a thickness in the 30-40 nm range coated on a Polyethylene naphthalate (PEN) polymer.

The third layer may be replaced with a different, more resistant dielectric.

The refractive index of at least one of the dielectric layers is preferably higher than 2.4.

The second layer of silver (Ag) can comprise pure silver or a silver alloy.

The stack of films 23 is preferably coated on the outer face of the substrate 22, i.e. the face that will face the sun/sky.

A second layer of polymer 24 may be added as a protection on top of the stack 21+22+23, thereby obtaining a structure made of one layer of polymer substrate coated by a stack of films and recovered by a second layer of polymer.

The polymer materials used for the substrate 22 and optionally for the protective layer 24 will be chosen to have good solar spectrum [400-2,500 nm] transmission.

In one example, the polymer material used for the substrate 22 and/or for the protective layer 24 has high absorbance (i.e. high emissivity) in the far infrared: (3′000 nm and above).

By encapsulating the stack of films 23 between two layers of polymer, the stack will also be better protected from the greenhouse climate improving life span of the film.

The polymer 22 and optionally 24 may also have good shear resistance, UV stability and flame-retardant properties, naturally or through additives. For example, Ethylene tetrafluoroethylene (ETFE), PEN, Polyester or Polyethylene with additives may be used as these polymers exhibits the above advantageous properties. The polymer 22, 24 has a thickness of no more than 200 microns and preferably no more than 120 microns.

A screen or net based on this example of filter is adapted to: prevent some or most of the NIR radiation to be transferred below the film; optionally reduce the radiation in the green spectrum; decreasing the amount of energy captured by the greenhouse; be low cost to produce; have low sensitivity to incidence angle with no risk to significantly reduce the level of red and far red transmitted to the crop.

However, this first example has the drawback that the thermal radiation that is emitted in the FAR infrared range by the vegetation, the soil and the structures in the greenhouse is also blocked by the filter 2, instead of being transmitted through the filter; this reduces radiative cooling.

To prevent thermal radiations radiated by the plants, soil and structure of the greenhouse, to be reflected by the filter and trapped within the greenhouse, the filter 2 preferably comprises a layer, for example the protective layer 24 or an additional layer, transparent in the ePAR range and adapted to absorb thermal radiation in the far infrared range, thereby increasing the temperature of the film including the stack which may then radiate thermal infrared both inside (FIR3) and outside (FIR2) the greenhouse, preferably in similar proportions. Therefore, at least part of the radiated energy will be absorbed by the filter and eventually leave the greenhouse. The additional layer is preferably a polymer which may be for example ETFE, which absorbs thermal radiations.

The polymer substrate 22 has a thickness of no more than 200 microns, preferably no more than 120 microns and is transparent to thermal infrared which is for instance the case of polyethylene.

In an example, a foldable screen may comprise stripes 20 of a filter according to the first example and other stripes 20 of a filter according to another example.

In an example, down-conversion additive, can be incorporated to the substrate. Different pigments organic or inorganic such as quantum dots or phosphorous pigments, have the property to absorb light in a given range of wavelength and emit light in another higher range of wavelength.

Integration of the strips in a foldable screen may be made according to different configurations.

In an example, reflective strips 20 are spaced altogether on the yarn framework or fabric in order to create empty space allowing the air to circulate as shown in FIG. 2. The ratio of the surface of strips and the surface of the screens fully deployed is typically in the range of 25-75%: For one reflective strip, we have an opening of one to three empty strip large to the next reflective strip. The benefit of such a configuration is to allow air and water vapor to flow through the screen and to not disturb natural ventilation, further the amount of smart reflective strips will be limited (cost advantage). The inconvenient is to reduce shading performance as light is not filtered when passing the different empty space.

In another example, reflective strips 20 are fixed relatively close to each other on the yarn framework or fabric. As a consequence, the screen has a closed structure, air and water vapor cannot flow through the screen and a forced ventilation system is used to exchange hot and humid air inside the greenhouse with cooler and dryer air outside. It is also possible to transfer sensible heat outside the greenhouse (for instance using a heat pump) and to condensate water vapor on a cold plate. According to this example, the shading performance of the screen is not reduced as the screen, in an unfolded (deployed configuration) is configured to let some or all the sunlight pass through it. The screen according to this example, is however more expensive as it may use more filtering strips and an extra ventilation as well as a heat transfer mechanism.

Given that the screen is configured to reflect as much as 60% of solar energy, the amount of air/heat to move outside the greenhouse will be reduced compared with a traditional greenhouse without any filtering screening system. The combination of a 100% filtering screen with a forced ventilation system and/or heat pump makes possible to build new or convert existing greenhouse in a (semi-) closed greenhouse and to operate them at a fraction of the cost of traditional (semi-) closed greenhouse as less energy are used to be transferred outside of the greenhouse.

Screen may be manufactured according to different manufacturing processes.

In an example, the film is cut in strips to be incorporated in a yarn framework to form a screen. The film used for the strips has to be thin enough to be compatible with current production process and later facilitate the folding and unfolding of the screen. The strips may for example have a thickness of about 20 to 50 microns but no more than 200 microns. The polymer substrate is selected according to its optical and mechanical properties such as spectral transfer function, UV resistance, flame retardant and compatibility with greenhouse/outside environment.

In an example, the polymer substrate is held for example on a roll and unwound from said roll. In a first treatment step, the substrate is heated to remove the non-volatile components. In a second step, a surface treatment may be performed on the substrate, for example argon plasma treatment to improve adhesion of the coatings on the substrate.

Then the next step is the coating perse with the desired thin film layers. This can be done using different technologies, for example by sputtering, e.g. DC sputtering or RF sputtering. The choice may depend on the material being deposited for the coating. For example, for Indium Tin Oxide (ITO), a DC sputtering may be used, for S1O2 a RF sputtering may be used. Instead of plasma treatment, an “adaptive thin film layer”, for example a Zinc Tin Oxide (ZTO) layer may be coated directly on the substrate surface before the other layers of the defined stack to improve the adherence of the other layers.

After the coating step, an additional layer of polymer may be added through lamination above the stack of films, then the film is again wound on a roll for future use or process steps. Additional steps may comprise measurements means, such as optical means, to control the deposited layers and their thickness or quality.

The film roll is then unwound to be cut in strips that will be incorporated in line in the yarn framework in the screen manufacturing process. To cut the strips, an ultrasonic device or alternatively a laser will be used to cauterize the lateral edges of the strips by melting the substrate.

The strips may be cut using for instance a state-of-the-art ultrasonic device that will make possible to cover the lateral edges of the strips by melted polymer from the substrate, thereby preventing water vapor to contaminate the stacks once the strips are incorporated in the screen and places in a humid environment.

1. A foldable screen for greenhouse, comprising:
a plurality of strips that are spaced apart, each strip comprising a filter, the filter comprising a substrate and at least one stack of films mounted on or adhering to the substrate, wherein the at least one stack of films is adapted to:
reflect solar infrared radiations in the spectral range from 850 nm to 2000 nm, and
be transparent to solar radiations in the spectral range from 400 nm to 750 nm.

2. The foldable screen of claim 20, the stack of films comprising:
the first layer being made of T1O2;
the second layer of Ag on top of the first layer;
the third layer of dielectric on top of the second layer.

3. The foldable screen of claim 2, the third layer comprising T1O2.

4. The foldable screen of claim 20, further comprising:
a seed layer of Cu, NiCr, NiCrNx or Au between the first layer and the second layer.

5. The foldable screen of claim 20, further comprising:
a blocking layer of cu blocking layer of Cu, NiCr, NiCrNx or Au between the second layer and the third layer.

6. (canceled)

7. The foldable screen of claim 20, wherein the at least one stack of films is adapted to reject at least 20%, at least 30%, or at least 40% of solar radiations in a green spectral range from 500 nm to 565 nm.

8. The foldable screen of claim 20, wherein the first, second and third layers have a thickness within the range respectively from 20 nm to 25 nm, from 20 nm to 30 nm, and from 30 nm to 40 nm.

9. The foldable screen of claim 1, further comprising:
a layer transparent in an ePAR range and adapted to absorb thermal radiation in the far infrared range, the layer being provided on a side of the filter that is intended to face a culture.

10. The foldable screen of claim 1, wherein the substrate is mounted onto a foldable canvas, the foldable canvas comprising a fabric.

11. (canceled)

12. The foldable screen of claim 1, wherein the substrate comprises a polymer film with a thickness of no more than 200 microns and preferably no more than 120 microns.

13. The foldable screen of claim 20, further comprising:
an additional layer transparent in the spectral range from 400 nm to 2500 nm and disposed on top of the at least one stack of films.

14. The foldable screen of claim 1, wherein the substrate comprises down-conversion particles.

15. A selective infrared filter apparatus for greenhouse, comprising:
a first foldable screen, and
a second foldable screen comprising a second foldable substrate and at least one stack of films coated on the second foldable substrate, wherein the at least one stack of films of the second foldable screen is adapted to transmit at least 70% of solar radiations within the range from 400 nm to 2500 nm when the radiations hit an active film at normal incidence, and to reject at least 80% or radiations within the range from 3000 nm to 50,000 nm,
wherein either of the first and second foldable filtering films may be unfolded to cover substantially a same area inside the greenhouse.

16. The selective infrared filter apparatus of claim 15, further comprising:
a first and a second actuable structure adapted to bring the first and second foldable screens respectively from a folded configuration to an unfolded configuration and vice a versa,
a driver configured to actuate the first and second actuable structure,
at least one motor arranged to power the driver, and
a computer configured to control the driver to selectively drive the first and second foldable screens, wherein the driver is controlled as a function of at least one parameter.

17. The selective infrared filter apparatus of claim 16, wherein the first and second foldable filters are selectively brought from the folded configuration to the unfolded configuration and vice a versa in order to regulate a temperature inside the greenhouse around a target temperature.

18. The selective infrared filter apparatus of claim 17, further comprising:
controlling the driver to bring the first foldable screen from the folded configuration to the unfolded configuration and to maintain or bring the second foldable screen from the unfolded configuration to the folded configuration, when a first condition is met, and
controlling the driver to bring the first foldable screen from the unfolded configuration to the folded configuration and to bring the second foldable screen from the folded configuration to the unfolded configuration, when a second condition is met.

19. A method of manufacturing a foldable screen for greenhouse, the foldable screen comprising a foldable substrate and a plurality of strips mounted on the foldable substrate for filtering solar spectrum, each strip comprising a stack of films coated on the foldable substrate, the method comprising:
providing the foldable substrate,
depositing several layers of coatings on the foldable substrate in order to obtain the at least one stack of films,
cutting the at least one stack of films in strips, and
mounting the strips onto a canvas.

20. The foldable screen of claim 1, wherein the at least one stack of films comprises:
a first layer of T1O2, ZTO, S13N4 or NBOx,
a second layer of Ag on top of the first layer, and
a third layer of dielectric on top of the second layer.

21. The method of claim 19, wherein the at least one stack of films is adapted to:
reflect solar infrared radiations in a spectral range from 850 nm to 2000 nm, and be transparent to solara radiations in a spectral range from 400 nm to 750 nm.
